(19) United States
(12) Patent Application Publication
(10) Pub. No.: US 2006/0053371 A1
(43) Pub. Date: Mar. 9, 2006

(54) Navigation and viewing in a multidimensional space

(76) Inventor: Thomas G. Anderson, Albuquerque, NM (US)

Correspondence Address: V. Gerald Grafe, esq., P.O. Box 2689, Corrales, NM, 87048, US

(21) Appl. No.: 11/244,584

(22) Filed: Oct. 6, 2005

Related U.S. Application Data
(63) Continuation-in-part of application No. 09/785,696, filed on Feb. 16, 2001, now Pat. No. 6,954,899.
(63) Continuation-in-part of application No. 08/834,642, filed on Apr. 14, 1997, now abandoned.
(63) Continuation-in-part of application No. 08/834,616, filed on Apr. 14, 1997, now Pat. No. 6,208,349.
(60) Provisional application No. 60/202,448, filed on May 6, 2000.

(51) Int. Cl. G06F 3/00; G06T 15/20

(52) U.S. Cl. 715/701; 345/427

(57) ABSTRACT

A display controller allows a user to control a base viewing location, a base viewing orientation, and a relative viewing orientation. The base viewing orientation and relative viewing orientation are combined to determine a desired viewing orientation. An aspect of a multidimensional space visible from the base viewing location along the desired viewing orientation is displayed to the user. The user can change the base viewing location, base viewing orientation, and relative viewing orientation by changing the location or other properties of input objects.

### CROSS REFERENCE TO RELATED APPLICATIONS

This application claims priority as a continuation-in-part of U.S. patent application Ser. No. 09/785,696 (“Anderson III”), filed on Feb. 16, 2001, incorporated herein by reference, which claimed the benefit of U.S. Provisional Application 60/202,448 (“Anderson II”), filed on May 6, 2000, incorporated herein by reference, and was a continuation-in-part of U.S. patent application Ser. No. 08/834,642 (“Anderson I”) and Ser. No. 08/834,616 (“Davidson”), now U.S. Pat. No. 6,208,349, each of which was filed on Apr. 14, 1997, each of which is incorporated herein by reference.

### BACKGROUND

This invention relates to the field of display of a multidimensional space, specifically apparatus for allowing a user to control navigation and viewing of a multidimensional space, or controlling the display of selected portions of a multidimensional space to a user and adapted for use with computer systems in virtual reality environments.

Computer visualization and interaction systems such as that described by Maples in “Muse, A functionality-based Human-Computer Interface,” Journal of Virtual Reality, Vol. 1, Winter, allow humans to interact with multidimensional information represented in a multidimensional space. Such information can represent many types of virtual reality environments, including the results of scientific simulations, engineering analysis, what-if scenarios, financial modeling, three dimensional structure or process design, stimulus/response systems, and entertainment.

In many of the applications, the multidimensional space contains too much information for the user to view or assimilate at once. Displaying different aspects of the multidimensional space can also aid human understanding. Consequently, the user must select portions of the space for viewing, usually by changing the position and orientation of the human's viewpoint into the multidimensional space. The human must navigate to different what-if scenarios, to visualize different parts of a simulation or model result, to visit different parts of a structure or process design, and to experience different stimulus/response situations or different entertainment features. While the ubiquitous mouse has all but conquered navigation in two-dimensional spaces, navigation in higher dimensions is still problematic.

The mouse and joysticks have seen use as multidimensional display controllers. They are inherently two-dimensional devices, however, and are not intuitive to use when adapted for use in more dimensions.

A three-dimensional spaceball has also seen use as a multidimensional display controller. A spaceball remains stationary while the user pushes, pulls, or twists it. The spaceball does not provide intuitive control of motion because the spaceball itself cannot move. A spaceball can control relative motion, but is ill-suited for large displacement or absolute motion. Booms and head mounted displays combine visualization display with multidimensional display control and can be intuitive to use in multidimensional applications. Booms and head mounted displays can be expensive, however, and the physical limits of the boom structure can limit intuitive navigation. For example, booms typically require an additional input device to control velocity. Booms can control relative motion, but are ill-suited for large displacement or absolute motion.

Other motion devices such as treadmills and stationary bicycles have seen use in multidimensional display control. These are often expensive and too bulky for desktop use. They are also intrusive, often requiring the user to be strapped in to the device. Changing directions in the dimensions using a treadmill or bicycle can also be non-intuitive.

Multi-dimensional tracked objects have also seen use as multidimensional display controllers. These can be intuitive since they can move in multiple dimensions, but they do not allow nonvisual feedback to the user. Tracking can also be difficult when, for example, an electromagnetically tracked device is used near large metal items or an acoustically tracked device is used in settings where line of sight is difficult to maintain.

There is an unmet need for multidimensional display controllers that are intuitive to use, suitable for desktop use, and robust enough for use in a wide range of multidimensional display situations.

### SUMMARY OF THE INVENTION

The present invention provides a multidimensional display controller adapted for use with multidimensional information, especially for use in virtual reality or other computer displays. The display controller allows a user to establish a base viewing location and a base viewing orientation. The user can also establish a relative viewing orientation. The display controller combines the base viewing orientation and relative viewing orientation to determine a desired viewing orientation. The display controller depicts an aspect of the multidimensional space visible along the desired viewing orientation. The user can establish the base viewing location and base viewing orientation by moving a user-defined point (or multiple points, which define an object) relative to the multidimensional space or relative to a separate reference frame, or by some other type of input such as by changing an input object. The user can change the relative viewing orientation by changing the location, orientation, deformation, or other property of an input object. The relative viewing orientation can also be changed by tracked user body motions, for example by tracked motion of the user's head or eyes.

Advantages and novel features will become apparent to those skilled in the art upon examination of the following description or may be learned by practice of the invention. The objects and advantages of the invention may be realized and attained by means of the instrumentalities and combinations particularly pointed out in the appended claims.

### DESCRIPTION OF THE FIGURES

The accompanying drawings, which are incorporated into and form part of the specification, illustrate embodiments of the invention and, together with the description, serve to explain the principles of the invention.

FIG. 1 is an illustration of the information flow in a multidimensional display controller according to the present invention.

FIG. 2 is an illustration of a reference frame and user point for control of base viewing location and base viewing orientation according to the present invention.

FIG. 3 is an illustration of a multidimensional display with base viewing location, base viewing orientation, and relative viewing orientation according to the present invention.

FIG. 4 is an illustration of a device that can control the relative viewing orientation.

FIG. 5 is a flow diagram of computer software suitable for use with the present invention.

FIG. 6 is a schematic illustration of the operation of a controller according to the present invention.

FIG. 7(a,b) is a schematic illustration of the operation of a controller according to the present invention.

FIG. 8 is a schematic illustration of the operation of a controller according to the present invention.

FIG. 9 is a schematic illustration of the operation of a controller according to the present invention.

FIG. 10 is a schematic illustration of the operation of a controller according to the present invention.

FIG. 11 is a schematic illustration of the operation of a controller according to the present invention.

### DETAILED DESCRIPTION

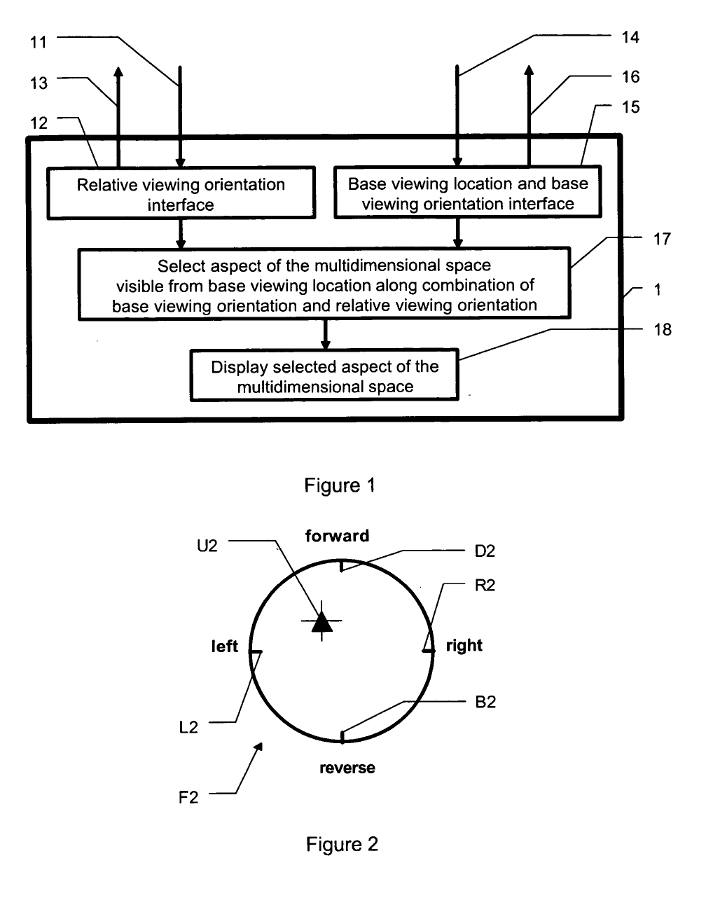

The present invention provides a display controller adapted for use with multidimensional information, especially for use in virtual reality or other computer displays. FIG. 1 illustrates the information flow in an example display controller 1 according to the present invention. A user can provide input 14 to indicate a base viewing location and base viewing orientation. Base viewing location and base viewing orientation interface 15 transforms the user input 14 to establish a base viewing location and base viewing orientation, and can provide feedback 16 associated with the base viewing location and base viewing orientation to the user. The user can also provide input 11 to indicate a relative viewing orientation. Relative viewing orientation interface 12 transforms the user input 11 to establish a relative viewing orientation, and can provide feedback 13 associated with the relative viewing orientation to the user. The display controller 1 combines the base viewing orientation and relative viewing orientation to establish a desired viewing orientation. The aspect of the multidimensional space visible from the base viewing location along the desired viewing orientation is selected 17. The display controller 1 depicts the selected aspect 18 to the user. Conventional display controllers generally limit the user to viewing the multidimensional space along the same direction as the user moves; i.e., the user always looks “straight ahead” in the multidimensional space. The user can turn to look in other directions, but that turning also changes the direction of motion (or next motion, if the user is not currently moving). The present invention provides for a separate viewing orientation control—a relative viewing orientation—that allows the user to move relative to the multidimensional space in a first direction, and look in a separate direction. See, e.g., Davidson FIG. 1; col. 5 lines 9-19.

The user can move the base viewing location and base viewing orientation by moving a user-defined point relative to the multidimensional space or relative to a separate reference frame. For example, the base viewing location can be translated through the multidimensional space in response to user translation of a device such as that described in U.S. Pat. Nos. 5,506,605 and 5,296,871, incorporated herein by reference. The base viewing location and base viewing orientation can also navigated through the multidimensional space by other user input such as voice commands. The display controller 1 can establish a separate reference frame. The separate reference frame can correspond to allowable directions and velocities of motion of the base viewing location and base viewing orientation. The direction of base viewing location motion can be determined from user motion commands or can be set relative to the base viewing orientation. Force or other feedback means can help make user motion of the base viewing location and base viewing orientation more intuitive. Representing the base viewing location and base viewing orientation as the location and orientation of a user-navigable craft can make navigation thereof intuitive. A user navigable craft can correspond to a vehicle separate from a representation of a character, or can correspond to a representation of a character. See, e.g., Anderson I pp. 10-11. FIG. 2 shows a reference frame F2 for controlling the base viewing location and base viewing orientation. The base viewing location can be translated forward D2 or back B2 and left L2 or right R2. The directions of translation are relative to the base viewing orientation, so that when the user points the base viewing orientation in a specific direction the forward direction of location translation points the same direction. This loosely corresponds, for example, to driving a conventional automobile where the driver always looks straight ahead. The user can establish the base viewing orientation in various ways. For example, the user can issue a command by voice or button to enable rotation of reference frame F2. The base viewing orientation would follow the rotation of reference frame F2. The user can thus control the base viewing orientation as though the user was in a craft capable of pointing in any direction.

For control of the base viewing location, a tracked device can be used to move a user point U2 relative to reference frame F2. Force, visual, or other feedback can be used to indicate the position of the user point U2 relative to the reference frame F2. The base viewing location can be moved in a direction derived from the base viewing orientation and the location of the user point U2 relative to the reference frame F2. The base viewing location can be moved at a velocity corresponding to the distance of the user point U2 from the reference frame F2 or the force applied by the user to the tracked device. The user can thus control the base viewing location as though the user were in a craft capable of motion in any direction.

Reference frame F2 can be communicated to the user in various ways. It can be displayed. It can conform to the frame of the navigable or multidimensional space, or to a reference frame corresponding to a navigable entity surrounding the user. The reference frame can be displayed as a sphere, ellipsoid, or polyhedron (in three dimensions) on the dashboard of a navigable entity, or can be displayed as a spatial form hovering near the user's head or where the user might expect to find a steering wheel in a conventional craft. The reference frame displayed can change under user control, or multiple reference frames can be displayed for the user to select.

Control from the user can be accepted in various other ways, including, for example, from force applied by the user to a pointer, from sound commands from the user, from pressure on a pressure sensitive input means, or from tracking selected user movements. The feedback to the user of the position of the user point relative to the reference frame can be done visually. It can also be accomplished with sound, for example by changing pitch or intensity as the desired viewing location and orientation change. It can also be accomplished by force feedback, for example by applying progressive resistance to movement away from a base viewing location or orientation. It can also be accomplished by other methods such as by varying the temperature of an input device, the speed of air flow over the user, or by varying vibrations in an input device, for example. The implementation of suitable sensor communication and control software is known to those skilled in the art.

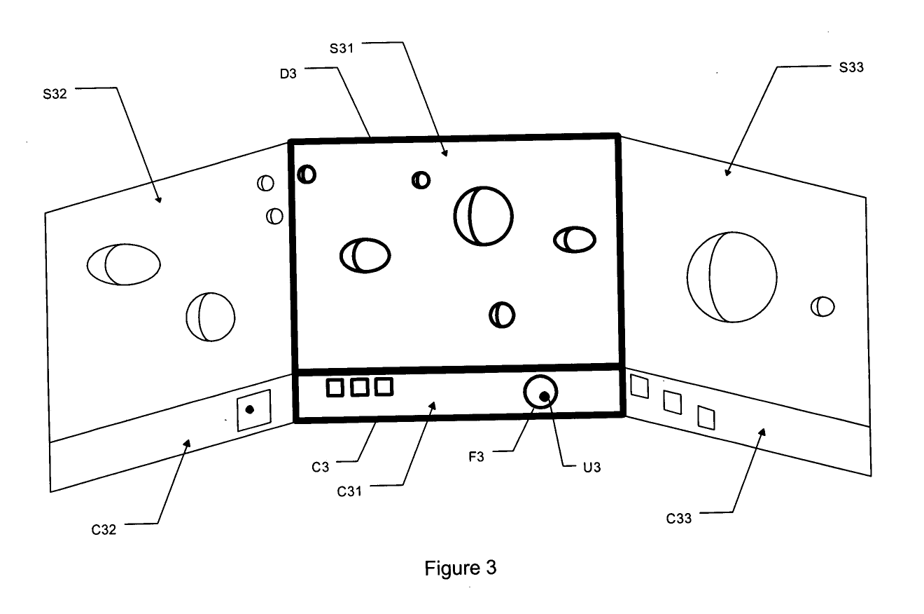

FIG. 3 is an illustration of three different aspects S31, S32, S33 a multidimensional space with base viewing location, base viewing orientation, and relative viewing orientation according to the present invention. The user can see the information displayed in display D3 and in control panel display C3. The user can see the aspect S31 of the multidimensional space displayed in display D3. The user can also see an assortment of controls in control panel C31 displayed in control panel display C3. Control panel display C3 and display D3 can be the same or different display devices. The aspect S31 displayed corresponds to the aspect of the multidimensional space visible from a base viewing location along a viewing orientation determined from a base viewing orientation and a relative viewing orientation. The user can manipulate user point U3 relative to reference frame F3 to change the base viewing location and base viewing orientation. The user can change the relative viewing orientation by separate input, such as those discussed below.

Rotating the relative viewing orientation to the left, without changing the base viewing location or base viewing orientation, will cause another aspect S32 of the multidimensional space to be displayed to the user in display D3. The control panel display C3 can continue to display the original control panel C31 when the relative viewing orientation is changed, corresponding to a fixed instrument panel like in a convention automobile. Alternately, the control panel display C3 can change to display the controls in control panel C32, corresponding to a cockpit that moves with the user or a heads up display.

Rotating the relative viewing orientation to the right, without changing the base viewing location or base viewing orientation, will cause another aspect S33 of the multidimensional space to be displayed to the user in display D3. The control panel display C3 can continue to display the original control panel C31 when the relative viewing orientation is changed, corresponding to a fixed instrument panel like in a convention automobile. Alternately, the control panel display C3 can change to display the control in control panel C33, corresponding to a cockpit that moves with the user or a heads up display.

Allowing separate user control of the relative viewing orientation has several benefits. The modification of viewing orientation separate from the control panel or other indicators of viewing position can help the user retain a spatial reference. In some applications, the user desires to change the viewing orientation much more rapidly than the viewing location (as when looking around when driving a car); using a free hand to control relative viewing orientation provides a low overhead way of accommodating the desired viewing orientation changes.

The relative viewing orientation can be changed by the user by changing the location, orientation, deformation, or other property of an input object. For example, the user can rotate a tracked object to rotate the relative viewing orientation. The user can also apply torque to an object to rotate the relative viewing orientation. Changes in other properties of an object can also be used to change the relative viewing orientation; for example, translation or deformation of an object can correspond to rotation of the relative viewing orientation. The relative viewing orientation can also be changed by tracked user body motions, for example by tracked motion of the users hand, head or eyes.

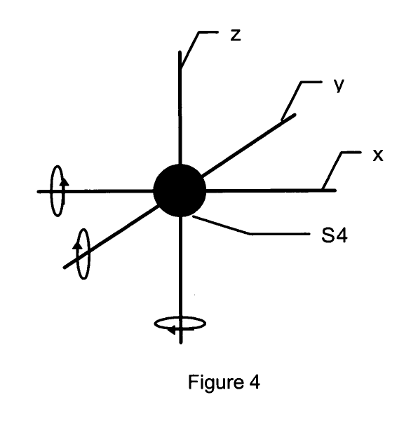

FIG. 4 illustrates a device that can control the relative viewing orientation. A sphere S4 is capable of rotation about three axes x, y, z. The display controller can track rotation of the sphere S4, and rotate the relative viewing orientation based on the rotation of the sphere S4. Intuitive user control can be fostered by allowing the device to represent the user's head. Rotating the device would accordingly effect a change in the displayed aspect corresponding to the rotation of the device.

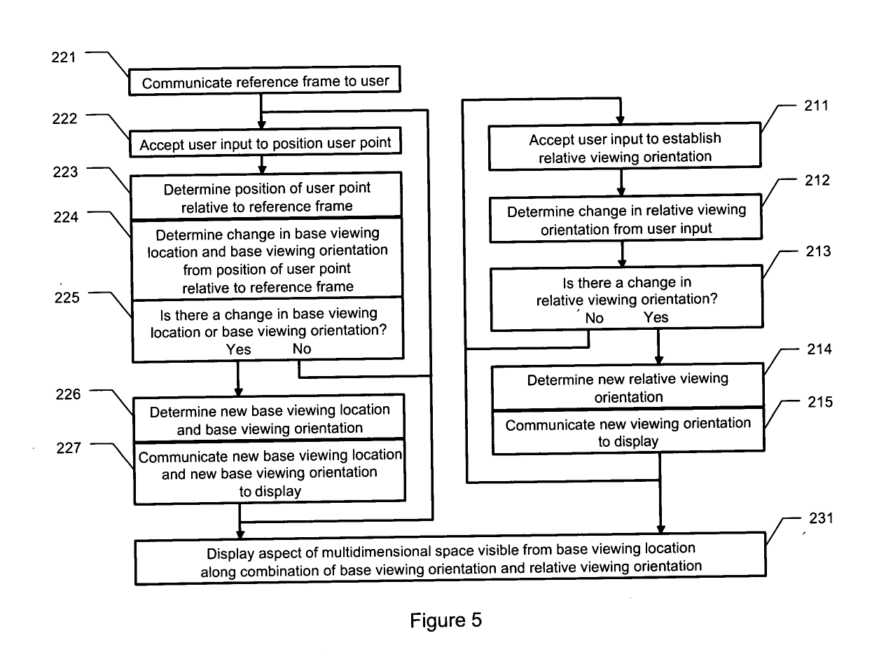

FIG. 5 is a flow diagram of a computer software implementation of a display controller according to the present invention. The display controller communicates a reference frame to the user 221. Those skilled in the art will appreciate various methods for accomplishing this, such as, for example, incorporating the reference frame into the image displayed to the user. Driver software specific to the user input device chosen accepts user input 222 for establishment of the position of a user point. The display controller determines the position of the user point relative to the reference frame 223. The relative position indicates whether the base viewing location and base viewing orientation have changed 224. If they have not changed 225, then the current base viewing location and viewing orientation are still valid, pending new user input 222. If the base viewing location or base viewing orientation has changed 225, then the display controller determines the new base viewing location or base viewing orientation 226. Those skilled in the art will appreciate various methods for determining the new base viewing location or base viewing orientation based on the relative position and the desired viewing location and viewing orientation navigation performance. The new base viewing location and base viewing orientation is communicated 227 to the display software.

The display controller also comprises appropriate driver software to accept user input for establishment of the relative viewing orientation 211. Those skilled in the art will appreciate suitable driver software corresponding to the input device employed. The user input can indicate a change in relative viewing orientation 212. If it indicates no change 213, then the current relative viewing orientation is still valid, pending new user input 211. If the relative viewing orientation has changed 213, then the display controller determines the new relative viewing orientation. Determination of the new relative viewing orientation can be based on numerous types of user input; those skilled in the art will appreciate methods for determining the relative viewing orientation based on the input device employed and the desired user responsiveness characteristics. The new relative viewing orientation is communicated to the display software 215.

The display software interacts with the multidimensional data to select the aspect visible from the base viewing location along a viewing orientation determined from a combination of the base viewing orientation and the relative viewing orientation. Those skilled in the art will appreciate methods of selecting aspects of multidimensional data for display. The display controller displays the selected aspect to the user 231.

A display controller according to the present invention was implemented using a Silicon Graphics Indigo II High Impact workstation running the IRIX 6.2 operating system. A PHANTOM™ from SensAble Technologies of Cambridge, Mass. was used as the means for allowing the user to set a user point, and for communicating force feedback to the user. Rotation of encoders on the PHANTOM™ was used for viewing orientation input. The PHANTOM™ was connected to the workstation's EISA communications port. Torque encoders on a spaceball, U.S. Pat. No. 4,811,608, from Spacetec were used to sense torque applied by the user to determine changes in relative viewing orientation desired by the user. The display controller was operated with a virtual reality environment like that described by Maples in “Muse, A functionality-based Human-Computer Interface,” Journal of Virtual Reality, Vol. 1, Winter 1995.

The representation of a user point presented to a user can comprise a graphical element such as a dot, an arrow, or a more complex graphical element such as a character or vehicle. The user point can comprise multiple points (the aggregation termed a “user object” for convenience of description), as described in Anderson I on p. 3 lines 6-8, p. 5 lines 4-7, and p. 7 lines 6-7. Such an aggregation of points can allow the position of the user point relative to the reference frame to include distances from the multiple points (or components of the object), which inherently allows “the position of the user object” to represent a multidimensional position; e.g., three dimensional position and orientation of the user object relative to the reference frame.

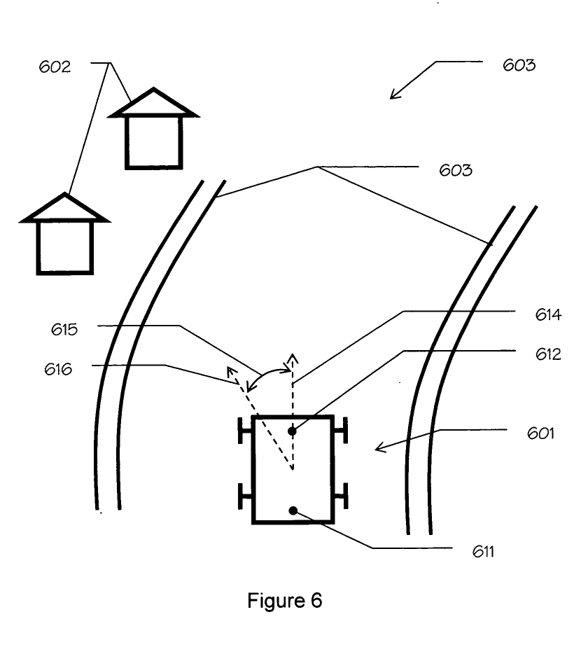

FIG. 6 is a schematic illustration of multiple user points communicated relative to a reference frame. A user object is represented by two user points 611, 612, and is communicated to the user as a top view of a vehicle 601. See, e.g., Anderson I p. 10 lines 22-25. A reference frame 604 is communicated to the user by a collection of familiar objects such as road boundaries 603 and structures 602. The user can position the user object 601 relative to the reference frame 604, for example by using a joystick or force feedback input device. See, e.g., Davidson col. 3 lines 37-39; Anderson I p 6 lines 18-27, p. 9 lines 12-24. The controller can change the display of the space responsive to the user input controlling the position of the user object; e.g., the controller can display the vehicle 601 at different positions relative to the reference frame 604. A base viewing location 613 can be established, as an example, at the center of the vehicle 601 (other base viewing locations, e.g., predetermined or controllable distances from the center of the vehicle, can also be suitable). A base viewing orientation 614 can be established, as examples, in the direction of motion of the vehicle body (current vehicle motion) or the direction indicated by the vehicle's tires (next vehicle motion). See, e.g., Anderson I p. 8 line 25-p. 9 line 11; Anderson II p. 11 lines 6-11. The user can establish a relative viewing orientation 615, in the figure shown as an angular offset from the base viewing orientation 614. The controller can combine the base viewing orientation 614 and relative viewing orientation 615 to determine a desired viewing orientation 616, and display to the user a view of the multidimensional space visible from the base viewing location 613 along the desired viewing orientation 616. In the figure, the controller would display a view to the side of the vehicle. The controller inherently can also display other parts of the multidimensional space; e.g., in some applications, the controller may also display parts of the space opposite the desired viewing orientation, or along the desired viewing orientation but behind the base viewing location (i.e., “backing up” the user along the desired viewing orientation).

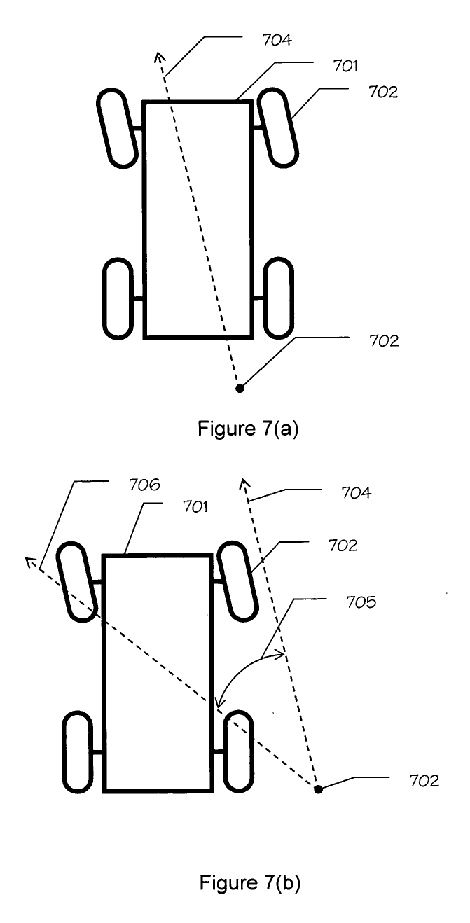

A reference frame can be established relative to the multidimensional space, for example, a representation of a vehicle, character, or other navigable entity can be presented to the user as part of the display of the multidimensional space. See, e.g., Anderson I p. 8 lines 25-27. The user can then position a user point within the multidimensional space, and the position of the user point relative to the reference frame used to determine a base viewing location and base viewing orientation. In a simple example, the position of the user point relative to the reference frame can directly correspond to the base viewing location (e.g., the base viewing location can appear to follow any apparent motion of the reference frame relative to the multidimensional space). The direction from the user point to some aspect of the reference frame, for example to the center of the representation of the navigable entity, can be established as the base viewing orientation. Additionally, the base viewing orientation can be controlled by the user point within limitations such that the angle of the base viewing orientation relative to the reference frame can be constrained to be within a maximum and minimum amount. FIG. 7(a,b) is a schematic illustration of a simple example of this correspondence. A reference frame 701 is presented as a representation of a wheeled vehicle. The front wheels 702 represent the base viewing orientation. See, e.g., Anderson I p. 8 line 25-p. 9 line 11. As shown in FIG. 7a, the base viewing location can directly correspond to the position of a user point 703, and the base viewing orientation 704 can correspond with the direction from the user point 703 to the center of the vehicle representation 701. The user can control the user point 703 to a point past predetermined limits of the maneuverability of the vehicle, as shown in FIG. 7b. The base viewing location still corresponds with the position of the user point 701. The base viewing orientation 704 corresponds with the direction established by the limit of maneuverability. A relative viewing orientation 705 can be determined as an angular offset required to direct the final, desired viewing orientation 706 through the center of the vehicle representation 701. The controller can display an aspect of the multidimensional space visible from the base viewing location 701 along the desired viewing orientation 706.

The motion of the user point, which directs the apparent motion of the vehicle by change of the portion of the multidimensional space display, can be controlled by the user with one or more hand-manipulable input devices such as joysticks. As an example, a first joystick can be used to indicate motion of the user point forward or backward along the base viewing orientation, allowing the controller to adjust the display to give the perception of motion along the base viewing orientation. A second joystick can be used to indicate motion of the user point around the reference frame, allowing the controller to adjust the display to provide displays of the multidimensional space visible at various angles to the vehicle's apparent motion. Separate control of base and relative views is also depicted in Davidson FIG. 1.

The position of the user point can be further communicated to the user using force feedback. See, e.g., Davidson col. 3 lines 37-39; Anderson I p 6 lines 18-27, p. 9 lines 12-24. For example, when the user point, or reference frame apparently moving responsive to the user point, encounters certain conditions (e.g., obstacles) in the multidimensional space, force feedback such as varying vibrations or directional forces can be communicated to the user. See, e.g., Davidson col. 3 lines 37-39, col. 4 lines 28-34; Anderson I p 6 lines 18-27, p. 9 lines 12-24. While shown in FIG. 7 as a planar arrangement for ease of illustration, the space can comprise more dimensions, and the user point can be moveable in more dimensions. For example, the space can comprise three dimensions, with the user point moveable in three dimensions, allowing the user to position the user point at various combinations of apparent left, right, above, and below the reference frame. As another example, the base viewing orientation and relative viewing orientation can be moveable in the same dimensions (e.g., both are moveable left-right in a plane in the multidimensional space). The user point can be moveable in perceptibly continuous increments over a range of values.

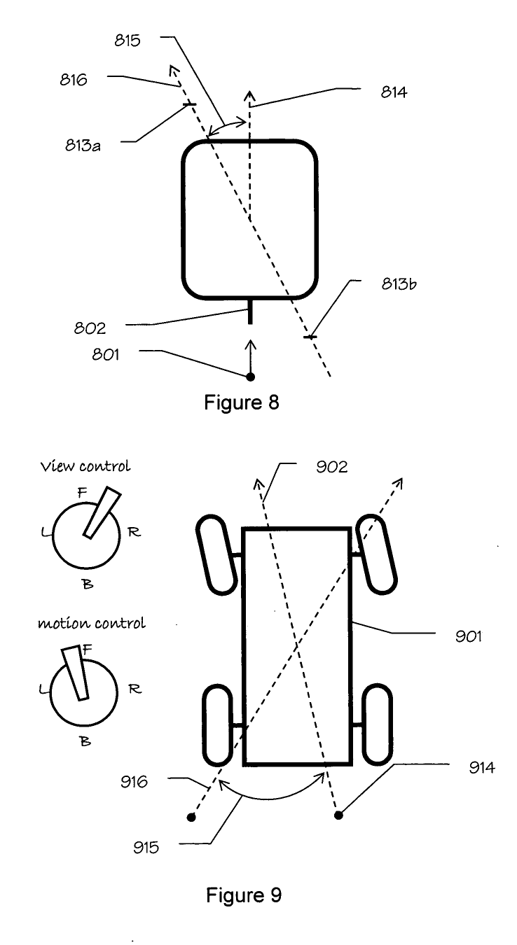

A reference frame can be established in relation to a multidimensional space, and communicated intuitively to the user as part of a display of the multidimensional space, e.g., as a representation of a vehicle, or as representations of objects in the multidimensional space. See, e.g., Davidson col. 4 lines 5-16; Anderson I p. 8 lines 25-27. The user can position a user point relative to the reference frame, for example by using a first input device, and the relative position used to determine a base viewing orientation 814, as illustrated schematically in FIG. 8. For example, the user can position a user point 801 relative to a point in the reference frame 814, with the direction from the user point to the reference point establishing a direction of apparent motion through the space. The position of the user point can be intuitively communicated to the user by changing the display to correspond to such apparent motion, or by changing the display of some object in the display (e.g., wheels on a vehicle or a directional indicator such as a rudder 802 or portion of a character or vehicle representation). See, e.g., Anderson I p. 8 line 25-p. 9 line 11; Anderson II p. 11 lines 6-11. The user can then establish a relative viewing orientation 815, for example by manipulation of a second input device or a different operation mode of the first input device. The controller can display an aspect of the multidimensional space visible along a combination 816 of the base viewing orientation 814 and the relative viewing orientation 815, from a desired viewing location anywhere along the combination (e.g., locations 813a, 813b). The base and relative viewing orientations can be controlled with one or more joysticks, and the position of the user point, the relative viewing orientation, or both, further communicated to the user with force feedback. See, e.g., Davidson col. 3 lines 37-39; Anderson I p 6 lines 18-27, p. 9 lines 12-24. The base and relative viewing orientations can also be controllable by the user in multiple dimensions, and in substantially continuous manners.

The present invention can be combined with various other methods of navigating through a multidimensional space. For example, as illustrated schematically in FIG. 9, a user can control the apparent motion of a character 901 (depicted in FIG. 9 for ease of illustration as a rectangle) through a multidimensional space (e.g., using a joystick). In the figure, the user has initiated a direction of motion 902 ahead and left. The location of the character can establish a base viewing location (e.g., from within the representation of the character, or ahead of or behind the representation, or above or below, or a combination thereof), and the direction of motion 902 of the character can establish a base viewing orientation 914. The user can then indicate a relative viewing orientation 915, which can be combined with the base viewing orientation 914 to determine a desired viewing orientation 916. The controller can display an aspect of the multidimensional space visible from the base viewing location along the desired viewing orientation 916. The capability to control a relative viewing orientation allows the user to have the effect of looking to the side or up or down while moving forward, or generally move in a direction other than the direction being displayed to the user, allowing a more realistic interaction with the multidimensional space. As a specific example, a reference frame can be established, for example corresponding to elements of the multidimensional space, or a representation of the character in the multidimensional space. The user can control the position of a user point relative to the reference frame, for example using a separate joystick. The position of the user point can be communicated to the user by an indication on a display (e.g., a directional indicator) or by the adjustment of the display as described below. The position of the user point can be used to indicate a relative viewing orientation.

A base viewing location and base viewing orientation into a multidimensional space can be communicated to the user with a character or vehicle metaphor. See, e.g., Davidson col. 3 lines 54-58, col. 4 lines 5-16. The location of the base viewing location in the multidimensional space can be presented as the location of a character or vehicle, generally one that is moveable by the user. The direction of the base viewing orientation can be presented as the direction of motion, or the direction of next motion if the base viewing location is currently at rest, in the multidimensional space. The direction of motion can be communicated by changes in the display of the multidimensional space, and can be communicated by indicators such as wheels, a rudder, a pointer, or some aspect of a representation of a character or vehicle that corresponds with or indicates a direction of motion. See, e.g., Anderson I p. 8 line 25-p. 9 line 11; Anderson II p. 11 lines 6-11. The metaphor can be reinforced by displaying a representation of the character or vehicle (sometimes called a “third person” view). The display can instead display only the portion of the multidimensional space visible from the character or vehicle (sometimes called a “first person” view). The user can control the motion of the character or vehicle relative to the multidimensional space in a variety of ways; e.g., the user can manipulate an input device to affect such motion, aspects of the application can affect such motion (e.g., the character can appear to be pushed in some direction), or a combination thereof. Once a base viewing location and base viewing orientation have been established, the present invention allows the user to control a relative viewing orientation. As an example, the user can manipulate a second input device to control a relative viewing orientation, extending the character metaphor to allow the character to look to one side while moving. The relative viewing orientation can be combined with the base viewing orientation to determine a direction in the multidimensional space, and a view of the multidimensional space along that direction communicated to the user. Combining the base and relative viewing orientations can foster more intuitive control by the user: the base motion of the character or vehicle is controllable, as is the viewing orientation relative to the base, in a manner resembling behavior practiced in the real world. The present invention can also allow the user to specify a relative viewing location, which can be combined with the base viewing location, and base and relative viewing orientations, to determine a location for the view presented to the user. As an example, the user can control a relative viewing location to move the starting location for the view along the combined viewing orientation, giving the appearance of moving behind or in front of the character or vehicle.

The user can control a relative viewing orientation in the above example by an input device such as a joystick. Another joystick can be used to control the apparent motion (the base viewing location and orientation) through the multidimensional space. Separate control of base and relative views is also depicted in Davidson FIG. 1. The joystick controls can also be combined in various ways to provide a desired user experience. The relative viewing orientation can comprise a three-dimensional input, allowing the user to apparently look sideways, up and down, or a combination. The relative viewing orientation can be substantially continuous over a range of directions. The controller can also provide feedback, such as varying vibrations communicated to the user, determined from one or more of the base viewing location, the base viewing orientation, or the relative viewing orientation, for example to communicate when the user is looking at a particular object or region in the multidimensional space, or to communicate when the user indicates motion of the base viewing location into a particular region or into collision with an object in the multidimensional space. See, e.g., Davidson col. 3 lines 37-39, col. lines 28-34

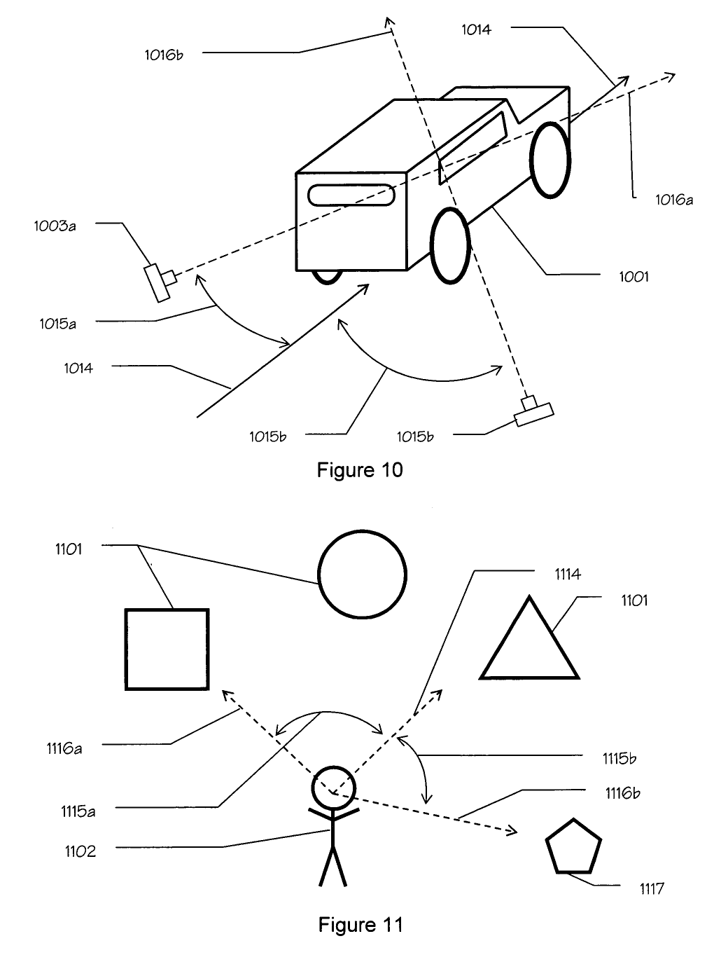

As another example, a reference frame can comprise a representation of a vehicle 1001, as shown schematically in FIG. 10. See, e.g., Anderson I p. 8 lines 25-27, p. 10 lines 22-25. The reference frame can be displayed to the user as part of the display of the multidimensional space. The vehicle 1001 can have a direction of motion, or of next motion, relative to the multidimensional space, indicated by changes in the display of other parts of the space, or by changes in the vehicle representation displayed (e.g., the direction of the vehicle wheels). See, e.g., Anderson I p. 8 line 25-p. 9 line 11. The direction of motion can establish a base viewing orientation 1014. See, e.g., Davidson col. 3 lines 46-47. The user can position a user point (shown at two separate positions 1003a, 1003b in the figure) relative to the reference frame 1001. The controller can determine an orientation required for the view from the user point to intersect a portion of the vehicle 1001, and display to the user a portion of the space visible along that orientation, thus communicating the position of the user point and allowing the user to control the view of the space by position of the user point. As an example, with the user point positioned at 1003a, the relative viewing orientation is 1015a, and the desired viewing orientation, and direction of view into the multidimensional space, is 1016a. If the user moves the user point to 1003b, then the relative viewing orientation is 1015b, and the desired viewing orientation, and direction of view into the multidimensional space, is 1016b. As an example, the user can interact with a first controller (such as a joystick) to control the motion of the vehicle. The user can interact with a second controller (such as a joystick) to control the user point. The two controllers can be combined, for example by using the user point as an input to the determination of direction of the vehicle (e.g., the vehicle can be directed to align with the desired viewing orientation). See, e.g., Anderson I p. 6 lines 11-13. Also, the control of the relative viewing orientation can be accomplished without explicit tracking of a user point; rather, the point of view into the space can be directly controlled by the user input.

FIG. 11 is a schematic illustration of operation of a controller according to the present invention. A base viewing location, shown in the figure as a representation 1102 of a character, can be moved relative to a reference frame 1101. See, e.g., Anderson I p. 11 lines 3-7. The reference frame can comprise, as examples, a grid imposed on a multidimensional space, selected objects represented in the space, or the coordinate system of the space itself, and communicated to the user by display of the grid, the selected objects, or any objects or features visible within the coordinate system. See, e.g., Davidson col. 3 lines 32-34, col. 5 lines 40-47; Anderson I p. 3 lines 8-10, p. 5 lines 20-22, p. 8 lines 10-11. The direction of motion of the base viewing location 1114 can establish a base viewing orientation, as described in Davidson col. 3 lines 34-37 and lines 46-47. The user can additionally control a relative viewing orientation, which, combined with the base viewing location and base viewing orientation, defines a view into the multidimensional space to be presented to the user. As an example, the user can establish a relative viewing orientation 1115a to the left of the base viewing orientation 1114, defining a desired viewing orientation 1116a. The controller can display to the user a view along the desired viewing orientation 1116a, conceptually allowing the user to view the rectangle while moving toward the triangle. In a three dimensional space, the user can establish a relative viewing orientation 1115b down and to the right of the base viewing orientation 1114, defining a desired viewing orientation 1116b. The controller can display to the user a view along the desired viewing orientation 1116b, conceptually allowing the user to look down at the pentagon 1117 while moving toward the triangle. The user can control the motion with a first hand-manipulable controller, and the relative viewing orientation with a second hand-manipulable controller. The operations of the two controllers can be combined in various manners to produce a desired user experience. The controller can supply additional feedback to the user, for example by varying vibrations or directional force feedback, to communicate additional information about the multidimensional space. See, e.g., Davidson col. 3 lines 37-39, col. 4 lines 28-34; Anderson I p 6 lines 18-27, p. 9 lines 12-24. For example, the controller can cause vibrations in a hand-manipulable controller when the base viewing location encounters an object in the space (information about collisions between the character and objects), or when the desired viewing orientation intersects an object in the space (information about the objects seen by the user).

The particular sizes and equipment discussed above are cited merely to illustrate particular embodiments of the invention. It is contemplated that the use of the invention may involve components having different sizes and characteristics. It is intended that the scope of the invention be defined by the claims appended hereto.

We claim:

1) A multidimensional display controller for displaying to a user an aspect of a multidimensional space visible from a base viewing location along a desired viewing orientation, comprising:
a) reference means for displaying to the user a reference frame having n dimensions, where n is at least two;
b) input means responsive to the user for determining the position of a user point relative to the reference frame;
c) feedback means for communicating to the user the position of the user point;
d) means for establishing the base viewing location and a base viewing orientation from the position of the user point relative to the reference frame;
e) orientation means responsive to the user for establishing a relative viewing orientation;
f) combination means for determining the desired viewing orientation from the base viewing orientation and the relative viewing orientation; and
g) display means for displaying to the user the aspect of the multidimensional space visible from the base viewing location along the desired viewing orientation.

2) A controller as in claim 1, wherein the orientation means comprises a first joystick.

3) A controller as in claim 2, wherein the input means comprises a second joystick.

4) A controller as in claim 1, wherein the relative viewing orientation is moveable in multiple dimensions.

5) A controller as in claim 1, wherein the relative viewing orientation can have any of a plurality of values.

6) A controller as in claim 1, wherein the feedback means comprises varying vibrations in an input device.

7) A multidimensional display controller for displaying to a user an aspect of a multidimensional space visible along a desired viewing orientation, comprising:
a) reference means for displaying to the user a reference frame having n dimensions, where n is at least two;
b) input means responsive to the user for determining the position of a user object relative to the reference frame;
c) feedback means for communicating to the user the position of the user object;
d) means for establishing the base viewing location and a base viewing orientation from the position of the user object relative to the reference frame;
e) orientation means responsive to the user for establishing a relative viewing orientation;
f) combination means for determining the desired viewing orientation from the base viewing orientation and the relative viewing orientation; and
g) display means for displaying to the user the aspect of the multidimensional space visible along the desired viewing orientation.

8) A controller as in claim 7, wherein the orientation means comprises a first joystick.

9) A controller as in claim 8, wherein the input means comprises a second joystick.

10) A controller as in claim 7, wherein the relative viewing orientation is moveable in multiple dimensions.

11) A controller as in claim 7, wherein the relative viewing orientation can have any of a plurality of values.

12) A controller as in claim 7, wherein the feedback means comprises varying vibrations in an input device.

13) A controller as in claim 7, wherein the user object is a user point.

14) A multidimensional display controller as in claim 15, further comprising:
a) input means responsive to the user for determining the position of a user point relative to the reference frame;
b) feedback means for communicating to the user the position of the user point; and wherein the
c) orientation means comprises means responsive to the user for establishing a relative viewing orientation from the position of the user point relative to the reference frame.

15) A multidimensional display controller for displaying to a user an aspect of a multidimensional space visible along a desired viewing orientation, comprising:
a) reference means for displaying to the user a reference frame having n dimensions, where n is at least two;
b) means for establishing the base viewing location and a base viewing orientation relative to the reference frame, comprising a first hand-manipulable input device;
c) orientation means responsive to the user for establishing a relative viewing orientation, comprising a second hand-manipulable input device;
d) combination means for determining the desired viewing orientation from the base viewing orientation and the relative viewing orientation; and
e) display means for displaying to the user the aspect of the multidimensional space visible along the desired viewing orientation.

16) A controller as in claim 15, wherein the means for establishing a base viewing location comprises means for establishing a current location and a direction of motion of the base viewing location relative to the multidimensional space, and wherein the base viewing orientation is determined from the direction of motion.

17) A controller as in claim 15, wherein the orientation means allows the user to establish the relative viewing orientation in two or more dimensions of the multidimensional space, and in two or more orientations in each such dimension.

18) A controller as in claim 15, further comprising communication of force or vibrations to the user.

19) A controller as in claim 15, wherein the orientation means comprises a first joystick.

20) A controller as in claim 19, wherein the means for establishing the base viewing location and a base viewing orientation comprises a second joystick.

21) A controller as in claim 15, wherein the relative viewing orientation is moveable in multiple dimensions.

22) A controller as in claim 15, wherein the relative viewing orientation can have any of a plurality of values.

23) A controller as in claim 15, further comprising a feedback means for communicating varying vibrations or directional forces to a user determined from one or more of the base viewing location, the base viewing orientation, or the relative viewing orientation.
